(19) United States
(12) Patent Application Publication
(10) Pub. No.: US 2012/0274583 A1
(43) Pub. Date: Nov. 1, 2012

(54) Multimodal Touchscreen Interaction Apparatuses, Methods and Systems

(76) Inventor: Ammon Haggerty, Oakland, CA (US)

(21) Appl. No.: 13/369,137

(22) Filed: Feb. 8, 2012

Related U.S. Application Data
(60) Provisional application No. 61/440,591, filed on Feb. 8, 2011.

(51) Int. Cl. G06F 3/041

(52) U.S. Cl. 345/173

(57) ABSTRACT

The MULTIMODAL TOUCHSCREEN INTERACTION APPARATUSES, METHODS AND SYSTEMS (“MTI”) transform multi-user, multi-modal touchscreen input gestures via MTI components into user-customized computation result displays. In one implementation, the MTI obtains, from a touchscreen sensor, a sensor signal including information on a user touch event on a touchscreen. The MTI determines location coordinates of the user touch event from the sensor signal. The MTI identifies a touch type of the user touch event from the sensor signal, and determines a user touchscreen gesture using the touch type of the user touch event. The MTI queries a memory for a user command associated with the user touchscreen gesture, and executing the user command via a processor.

### PRIORITY CLAIM

This application claims priority under 35 USC §119 to U.S. provisional patent application Ser. No. 61/440,591 filed Feb. 8, 2011, entitled “APPARATUSES, METHODS AND SYSTEMS FOR MULTIMODAL INTERACTIONS WITH LASER LIGHT PLANE TOUCH SCREENS,” attorney docket no. 21445-002PV. The entire contents of the aforementioned applications are expressly incorporated by reference herein.

This patent for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address apparatuses, methods, and systems for human-computer interaction, and more particularly, include MULTIMODAL TOUCHSCREEN INTERACTION APPARATUSES, METHODS AND SYSTEMS (“MTI”).

### BACKGROUND

Electronic displays provide visual information for users. Some computer systems include mechanisms for the user to provide input in response to visual information provided by an electronic display. For example, the computer system may include a touchscreen. A user may apply pressure on a portion of the touchscreen as a mechanism for providing input into the computer system.

### BRIEF DESCRIPTION OF THE DRAWINGS

The accompanying appendices and/or drawings illustrate various non-limiting, example, inventive aspects in accordance with the present disclosure:

FIGS. 1A-B show block diagrams illustrating example aspects of multimodal touchscreen interaction in some embodiments of the MTI;

FIGS. 2A-D show block diagrams illustrating example aspects of multimodal touch sensing in some embodiments of the MTI;

FIG. 3 shows block diagrams illustrating example aspects of light-based touch input recognition in some embodiments of the MTI;

FIGS. 4A-B show logic flow diagrams illustrating example aspects of multimodal touch processing in some embodiments of the MTI, e.g., a Multimodal Touch Processing (“MTP”) component 400;

FIG. 5 shows a logic flow diagram illustrating example aspects of touch coordinate determination in some embodiments of the MTI, e.g., a Touch Coordinate Determination (“TCD”) component 500;

FIG. 6 shows a logic flow diagram illustrating example aspects of touch type identification in some embodiments of the MTI, e.g., a Touch Type Identification (“TTP”) component 600;

FIGS. 7A-B show logic flow diagrams illustrating example aspects of touch group resolution in some embodiments of the MTI, e.g., a Touch Group Resolution (“TGR”) component 700; and

FIG. 8 shows a block diagram illustrating embodiments of a MTI controller.

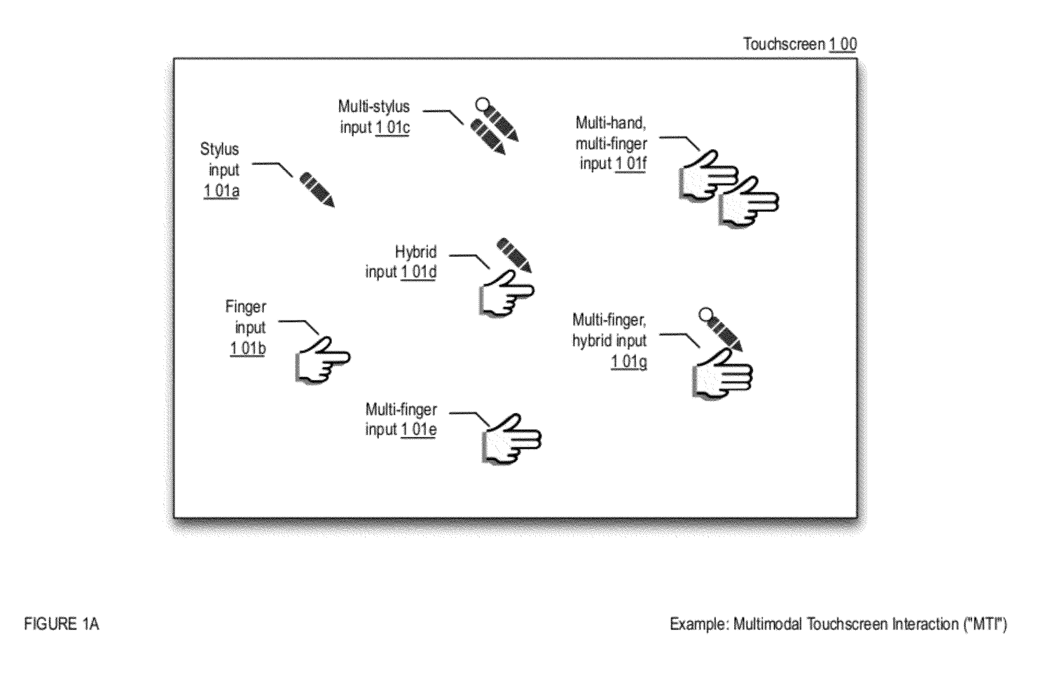

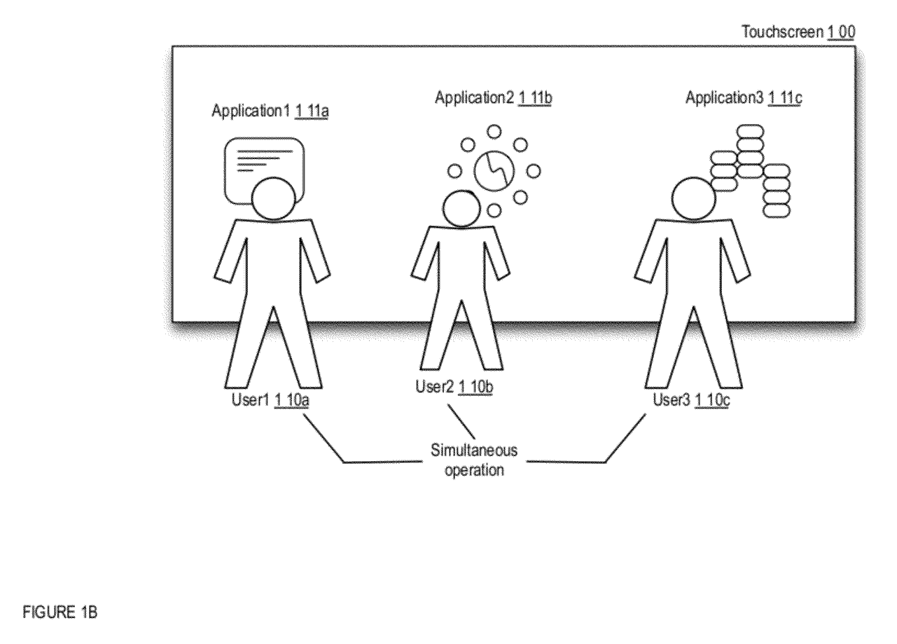

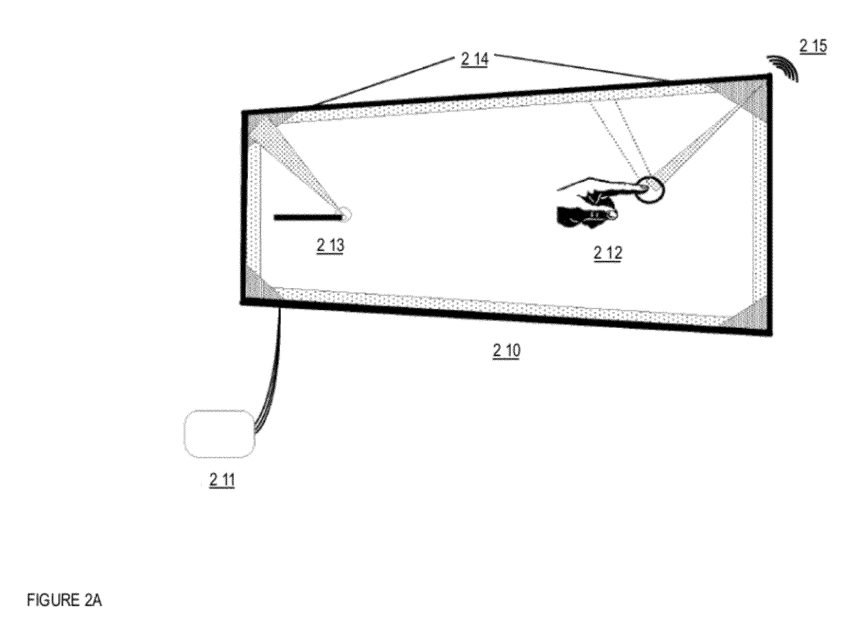

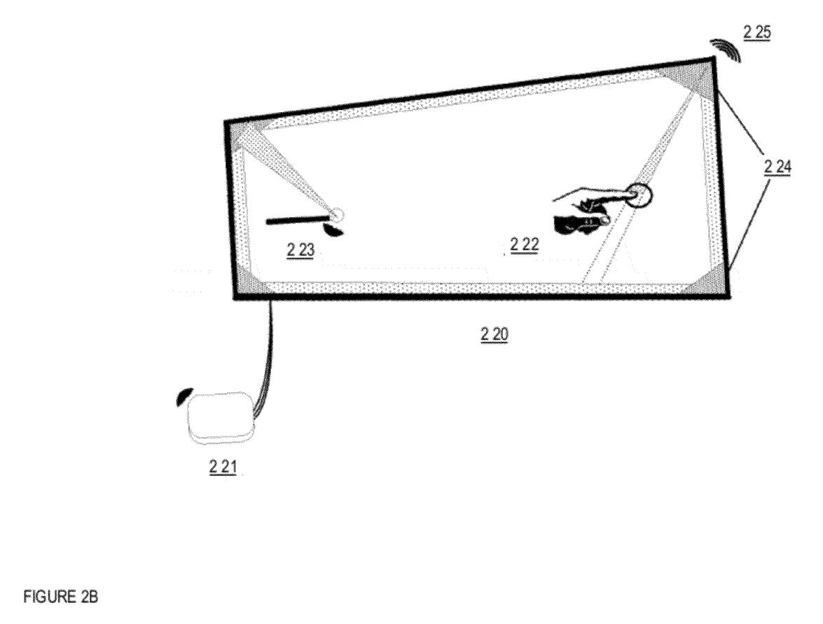

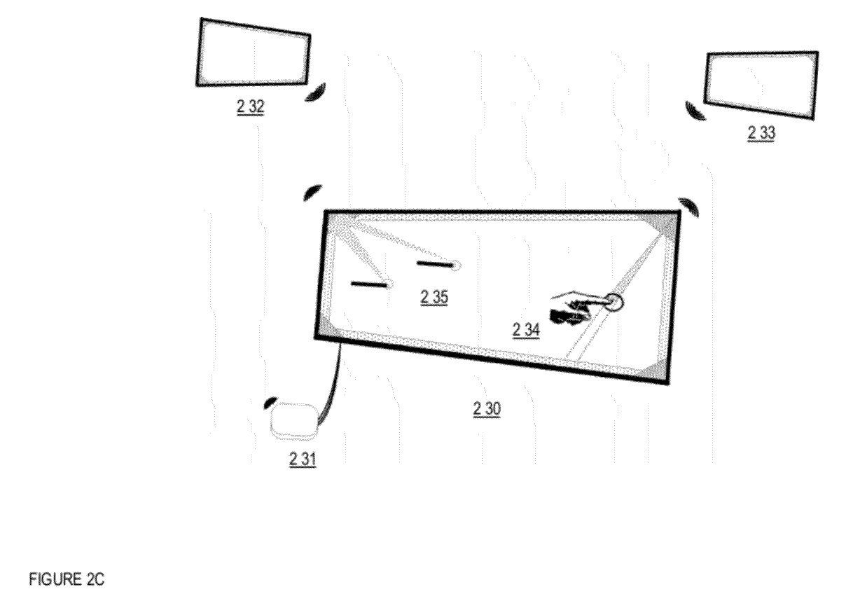

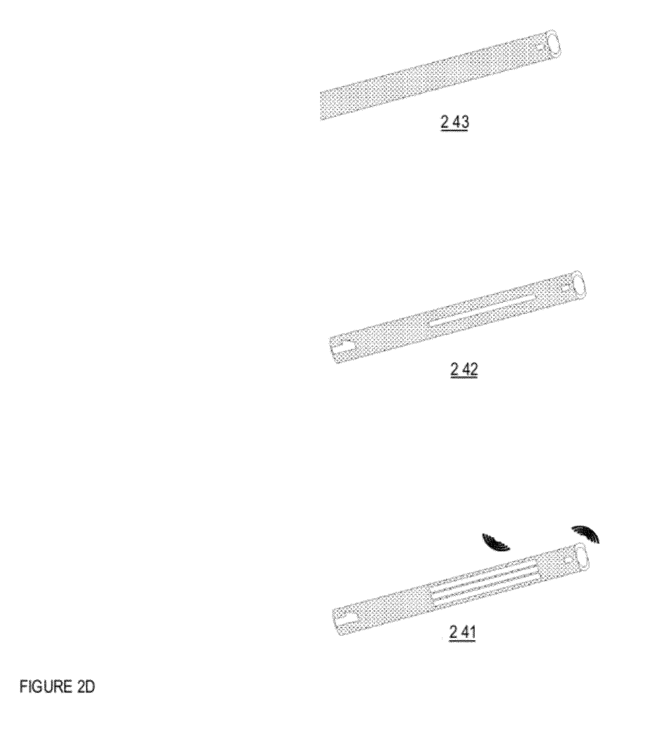

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### Multimodal Touchscreen Interaction (MTI)

The MULTIMODAL TOUCHSCREEN INTERACTION APPARATUSES, METHODS AND SYSTEMS (hereinafter “MTI”) transform multi-user, multi-modal touchscreen input gestures, via MTI components, into user-customized computation result displays. FIGS. 1A-B show block diagrams illustrating example aspects of multimodal touchscreen interaction in some embodiments of the MTI. With reference to FIG. 1A, in some embodiments, the MTI may provide a touchscreen 100. For example, a user may touch a display provided by the MTI with a finger or hand or object such as a stylus. The touchscreen may be an electronic visual display that can detect the presence and location of a touch within the display area, and translate the detected touch into a processed interaction with content being displayed. The MTI may provide a mechanism whereby virtual overlays or surfaces may receive user input entering, interacting with or touching a given surface comprising or hosting a display. In some implementations, the touchscreen may comprise a frame outlined or supported with sensors designed to detect subtle physical and ambient changes in the touchscreen or its vicinity. The sensors may detect and track the contact of a variety of objects on a defined surface in space and time. In some implementations, the touchscreen surface may include, without limitation, an overlay on a digital display, e.g. a Liquid Crystal Display (LCD), plasma display, rear projection, Light-Emitting-Diode (LED), Organic Light-Emitting-Diode (OLED) and/or the like. Other non-digital displays, e.g., irregularly or curved wall surfaces may also embody the touchscreen surface. In some embodiments, the MTI may provide multi touch screens designed to simultaneously detect and interpret two or more distinct touch events on a single display, including those which can interpret various “gestures” made by two or more fingers. The MTI may implement multi-touch touchscreens using any of the various touch detection and tracking implementations discussed herein. Accordingly, the MTI may enable gesture interpretation capabilities, thus providing a rich and sophisticated array of user interactions with displayed content. In some embodiments, the MTI may facilitate a single user to provide a single type of input (e.g., stylus input 101a, finger input 101b, etc.). In some embodiments, the MTI may facilitate a single user to provide multiple simultaneous input touches (e.g., multi-stylus input 101c, hybrid stylus-finger input 101d, multi-finger input 101e, multi-hand, multi-finger input 101f, multi-finger hybrid stylus-finger input 101g, and/or like combinations).

With reference to FIG. 1B, in some embodiments, the MTI may facilitate a number of users (e.g., user1 110a, user2 110b, user3 110c) to simultaneously provide inputs such as those described above with reference to FIG. 1A into the touchscreen 100. In some embodiments, each user may be interacting with a separate executable application (e.g., application1 111a, application2 111b, application3 111c) displayed on the touchscreen provided by the MTI. In such embodiments, the MTI may receive, distinguish, and uniquely identify each of the (possibly simultaneous) inputs from each of the (possibly simultaneously acting) users and associate the inputs of each of the users to the respective applications they are interacting with on the MTI. In some preferred embodiments, the MTI may recognize, and distinguish between, finger and stylus inputs of the users such that both finger and stylus inputs may be sensed as contacting the screen as different types of touches. In such embodiments, the MTI may adapt the user interface of an application being displayed on the touchscreen to behave differently when a finger interacts with it as opposed to when a stylus interacts with it. In some embodiments, the features provided by the application for the user may vary depending on whether the user utilizes a finger or a stylus to interact with the application (for example, even when the shape of the user's gesture on the touchscreen of the MTI is the same with the finger and the stylus). As an example of this, a finger touch-based gesture may provide the user with an eraser tool in a drawing application, while the same gesture using a stylus may provide a drawing tool in the drawing application. In some embodiments, some user controls may be activated by stylus touch (and for example, not by a finger touch), enabling new hybrid touch gestures defined by how the stylus and finger are used simultaneously in a gesture. In some embodiments, touchscreen application software (or “apps”) may dedicate and/or divide specific tracking processes to be performed on either the finger or stylus, or both. As an illustrative, non-limiting example, a touchscreen application executing on the MTI may apply additional smoothing when fingers are used to draw compared to when a stylus (or styli) are used to draw in the application.

FIGS. 2A-D show block diagrams illustrating example aspects of multimodal touch sensing in some embodiments of the MTI. With reference to FIG. 2A, in various embodiments, the MTI may include touchscreens that utilize, for touch sensing, a wide variety of technologies including, without limitation, resistive/capacitive films, “overlays” comprising a frame mounted on a display surface, cameras observing a surface from behind, audio sensors for triangulating the position of an object based on the acoustic vibrations the object makes as it moves around the display surface. In some embodiments utilizing resistive/capacitive touchscreens, the sensors may be made of a plastic polymer providing pre-calibrated and optimized resilience and flexibility, and host an electrostatic field that is sensitive to distortions caused by proximity to or contact with electro-statically charged objects such as a finger. The MTI may provide resistive/capacitive touchscreens may that include extendable sensitivity ranges and proximity sensing capabilities. In some embodiments, the overlay surface may be pressure sensitive measuring the amount of force being applied to the surface. In some implementations, the touchscreen may include the use of high resolution pixel sensors, with fast refresh rates (e.g., over 120 Hz), high contrast ratios with no-haze transparency. The touchscreen sensors may be automatically calibrated or customized to user/group preferences, application being executed, environmental conditions in the vicinity of the touchscreen, etc. The various implementations described above may be combined in touch screens that detect, track or interpret touch interactions using multiple modes.

In some implementations, a laser light plane (LLP), infrared (IR) or other optical waves may be projected across the display surface and a touch detected through sensors when an object disturbs the projected optical waves. For example, in some embodiments, a touchscreen 210 may incorporate the display surface with infrared light sources 215 mounted to shine light parallel to the surface, and sensors mounted to observe this light and any disturbance to it. In some embodiments, the touchscreen display surface may be flat, but in others may be operatively curved for certain types of curvature, e.g. a cylinder section. Without limitation, embodiments may operate for varying wavelengths of electromagnetic radiation, e.g. visible light.

Some embodiments may utilize a rectangular frame 211 around a portion of the surface, with infrared light sources and sensors embedded in the frame. In some embodiments, infrared light sources may be incorporated (e.g., continuously, with periodic spacing, at equal angular spacing as observed from a predetermined reference point, etc.) around the interior of the frame, and sensors may be located in two or more corners of the rectangular frame (see 214). In other embodiments, light emitters and sensors may be embedded as matched pairs across from each other in the frame, e.g. one side of frame may include emitters, and the opposite side may include sensors corresponding to these emitters. In some embodiments, a frame around a touch screen may include a hybrid set of sensors at different sensitivity levels, resolutions and/or timing attributes. In some embodiments, illumination sensors may be positioned on the sensing plane, e.g. one-dimensional IR-LEDs. The frame may also include multiple sensors positioned strategically over a given interaction region. In some embodiments, the touchscreen may include sensors outside the surface plane, e.g. two-dimensional via complimentary metal-oxide semiconductor (CMOS) and IR Laser Diodes. With sensors outside the planar surface, interaction with the touchscreen may not require the touch object and/or stylus physically contact the surface, and permit the touchscreen to receive remote interactive input, e.g. from a mobile or remote device. In various embodiments, the object interacting with the touchscreen may take many forms. In one embodiment, the object being detected may be a finger, a stylus, or a member having a distal end with a predefined pattern, e.g. a regular or irregular shape.

In one embodiment, the touchscreen may triangulate multiple sensor readings to determine an object's location. In some embodiments, a stylus with an infrared light emitter may be used to interact with the touchscreen. The touchscreen may detect the infrared light stylus via light sensor (either observing from behind the screen or in plane of screen) as a bright spot. In some embodiments, the touchscreen may emit infrared light to detect a finger touch action through reflection or occlusion. Some screens may also embed infrared light sources shining in plane of touchscreen, so that finger touching screen is illuminated by IR light and is detectable as a bright spot in light sensors.

In some embodiments, an overlay frame around the touchscreen may include embedded infrared lights shining parallel to the surface and light sensors that sense increased brightness when objects break a defined plane to reflect light back to sensors. As illustrated in FIG. 2A, in some embodiments, a touchscreen panel may receive input from a finger 212 and stylus 213 simultaneously while tracking each independently. In some embodiment, e.g. sensors 214 may be tuned to detect emitted light from the stylus or reflected light because of the finger touch. In such embodiments, the intensity of light emitted by the stylus 213 may be brighter than the light reflected by the finger touch or the normal intensities of the light emitted above the plane of the screen in the absence of a user touch.

In some embodiments, the overlay frame may include an embedded infrared light source shining parallel to surface, and sensors that detect when light is blocked by an object (such as a finger) making contact on the surface between the light source and sensor. With reference to FIG. 2B, some embodiments may utilize touchscreens where touches are detected by blocked or occluded light. In such embodiments, the instance of a touch event 222 may be detected via sensors 220 tuned to recognize breaks in or lowered intensity of emitted or transmitted light 225, and then the location of the detected touch event may be triangulated (e.g., via touch processor 221) and tracked based on the occlusion patterns obtained by several sensors. In some embodiments, a distinction algorithm may instruct the sensors to detect locations that are significantly brighter than normal (e.g., when light/RF emitters from a stylus 223 are on), and those significantly darker than normal (e.g., when a finger 222 blocks or reduces the light plane above the screen surface). In such embodiments, brighter than normal screen interactions may be interpreted as stylus touches 223, and darker than normal on may be interpreted as finger touches 222. In some embodiments, the stylus 223 may include an RF transmitter, and the position of the stylus may be triangulated using two or more sensors 223 embedded in the overlay frame of the touchscreen.

With reference to FIG. 2C, in some embodiments, a touchscreen panel 230 may receive input from a finger 234 and styli (see 235) while communicating with other touchscreens 232-233 over a network. The touch interactions detected at the input touchscreen panel 230 may be tracked and processed by touch processor 231 into an output that may be displayed at all screens 230, 232-233 that are networked. In some embodiments, networked screens 232-233 may themselves be touch screens with features similar to those of touchscreen 230. In some embodiments, the networked touchscreens may include a number of additional input types including camera based touch/proximity input screens (e.g., surface backed cameras, front mount cameras, rear positioned cameras), resistive/capacitive touch screen-based input screens, and/or the like.

In some embodiments, the styli utilized (see 235) may include an IR LED or RF transmitter at the tip, which may be optionally activated by applying pressure against or proximity to a touch screen surface. The styli may also include a switch attached externally or embedded, for closing an electrical circuit that may activate the LED or RF transmitter when the stylus is actuated or pressed against an object. In some embodiments, the sensors may distinguish between multiple styli 235. For example, a given stylus with an LED in tip may continuously emit IR light while in contact with a touch screen surface where it is detected and tracked by sensors trained on the display surface (either in plane, from behind or in front). With multiple styli emitting the same light, sensors may read a series of similar bright spots without distinguishing between them. In some embodiments, the IR LED of a particular stylus may blink on and off, where different styli may use a different pattern or frequency of blinking, enabling the sensors to distinguish between them. While frequency patterns permit distinction, some touchscreens may also benefit from precise tracking.

In some embodiments, each stylus may create a different spatial pattern of light when contacting/approaching the touchscreen surface. With an appropriately defined stylus size and sensor range, patterns may be recognizable when stylus is at various locations relative to the IR sensors. In some embodiments, the styli may include color LEDs to enhance contrast for the sensors. Implementations may include two LEDs where their brightness varies over time. This way, stylus may be continuously visible to sensors (doesn't goes dark), but modulation between “bright and brighter” can be performed in different time patterns or frequencies so that different styli may be distinguished. Thus, high fidelity location tracking may be retained while allowing multiple stylus tracks to be distinguished from each other. In some embodiments where the touchscreen is distinguishing between multiple styli, the touchscreen may associate a different drawing mode (e.g. color, stroke style, etc.) with each stylus; draw and erase mode, user/stylus associations, turn-based controls, read/write/execute permissions for portions of the touchscreen. In addition, a different stylus associated with each user may keep track of which user draws what.

FIG. 2D illustrates examples of input styli. For example, input member 243 is a stylus with an IR LED at a given distal end. In one embodiment, the input member may include an IR LED pair located at a proximal end. The stylus input member may include a toggle switch for turning the stylus on/off and/or control additional stylus functions 242. A linear touch sensitive slide may provide further control, e.g. precision of line weight outputted to the touchscreen. In one embodiment, the stylus 241 may include wireless communication hardware, an audio microphone and/or embedded biometric identification software. The styli of FIG. 2D may further include an RF transmitter/receiver for sensor triangulation and identification purposes. In one embodiment a stylus identifier, stylus ID may be associated with different time modulation patterns. Each ID may be associated with a different time frequency of a sinusoidal or step pattern, offset well above zero brightness. In further embodiments, the stylus ID may include a Morse code-like time patterns. Implementations may further include LED pairs at both ends of a stylus, each end using a different time modulation pattern. In one embodiment, a switch on side of stylus-pen may be used to change time modulation pattern, and hence switch “ID” of stylus. Time modulation pattern recognition may occur with some delay from first observation of a stylus on a touch screen surface. However, for high frequency patterns, and sensors that operate at high frame rate, this delay can be very small. In addition, when a stylus contact is initially observed, it may be associated the same ID as the most recently observed stylus in the area. Hence, this initial estimate can be used until observations can be used to verify or correct the stylus ID(s) a few frames later, and this initial estimate may be likely to be correct a very high percentage of the time for normal touchscreen usage.

In one embodiment, a stylus may include a Radio Frequency (RF) transmitter antenna and/or receiver to establish communication with the touchscreen. Implementations of a stylus and touchscreen utilizing RF transmissions may use radio waves to transmit signals between a transmitter and a receiver. The stylus antenna may be attached to a stylus transmitter unit embedded in the stylus or otherwise coupled in operative communication. Depending on the implementation, the stylus transmitter is positioned in a manner allowing the touchscreen receiver to receive signals from the stylus. In one embodiment, the RF communications between the styli may occur over single channel and/or multi-channel systems. One embodiment of a multi-channel system may further include a channel selector on an RF stylus and/or touchscreen transmitter/receiver.

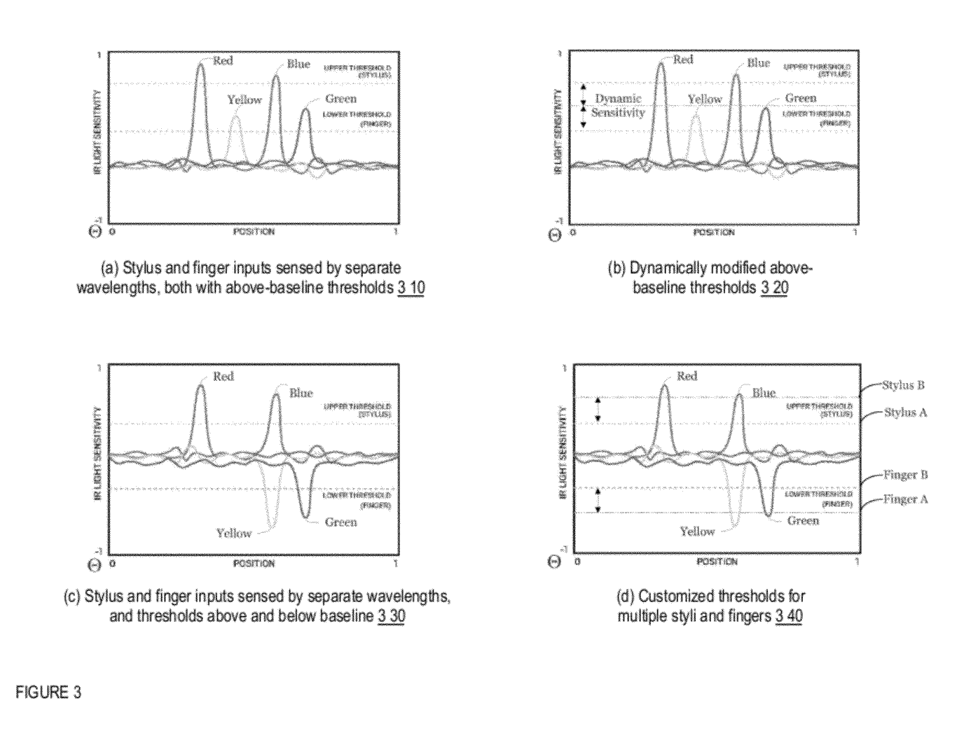

FIG. 3 shows block diagrams illustrating example aspects of light-based touch input recognition in some embodiments of the MTI. Sub-FIGS. 3(a)-(b) illustrate example output graphs of IR light sensitivity to stylus and finger input touches, where finger touches are detected by measuring reflection caused by the finger touch. In one embodiment, normal light levels may be measured as seen by sensors when IR light sources are on, and set two thresholds, one relating to finger touches and one to stylus touches. In some embodiments such as described in Sub-FIGS. 3(a)-(b), both thresholds may be above the normal light level and the stylus threshold may remain the still the higher one.

Sub-FIGS. 3(c)-(d) illustrate example output graphs of IR light sensitivity to stylus and finger input touches, where finger touches are detected by measuring occlusion caused by the finger touch. In one embodiment, the graphs may show what a 1D camera sees at each of many angles in plane of surface. So, horizontal axis “theta”, for example, may refer to an angle the IR imager is looking at. In one embodiment, the threshold lines may be dynamically varying rather than the constant level, as noted by the arrows. For example, the MTI may assume a noisy, non-uniform baseline light level, and set the threshold to have the same shape, but offset above or below. Or the MTI could calculate the thresholds required as a percentage (e.g. 120% or 80%) of the normal light level at each position in the graph, where the normal light levels may vary over the touchscreen space, and in time as well.

For example, in some embodiments, the sensors may measure and define a normal light level observed by each sensor when IR sources are turned on. The touchscreen software may set “threshold1” above this normal light level, and detect stylus touches where brightness exceeds this threshold. In one embodiment, it may set “threshold2” below this normal light level, and detect finger touches where brightness falls below this second threshold. Without limitation, thresholds may be set differently for each sensor, and may be spatially varied if the sensor is operable to see a range of spatial locations along plane of screen. This may include a non-uniform “normal” brightness level and non-uniform thresholds above and below. The calibration of touch overlay software may be set so that neutral (no contact with finger or stylus) represents a middle value. In one embodiment, the touchscreen may detect, interpret and differentiate touch interactions from multiple object types (e.g., fingers and styli), and also touch interactions from more than one of the same object type (e.g., distinct styli), whether from a single or multiple users. As discussed in greater detail below, one embodiment may be implemented with touch screens using any one or combinations of the physical detection modes described herein. In a preferred embodiment, one embodiment may be implemented with touch screens using at least optical touch detection or a combination of optical detection with radio frequency signal detection.

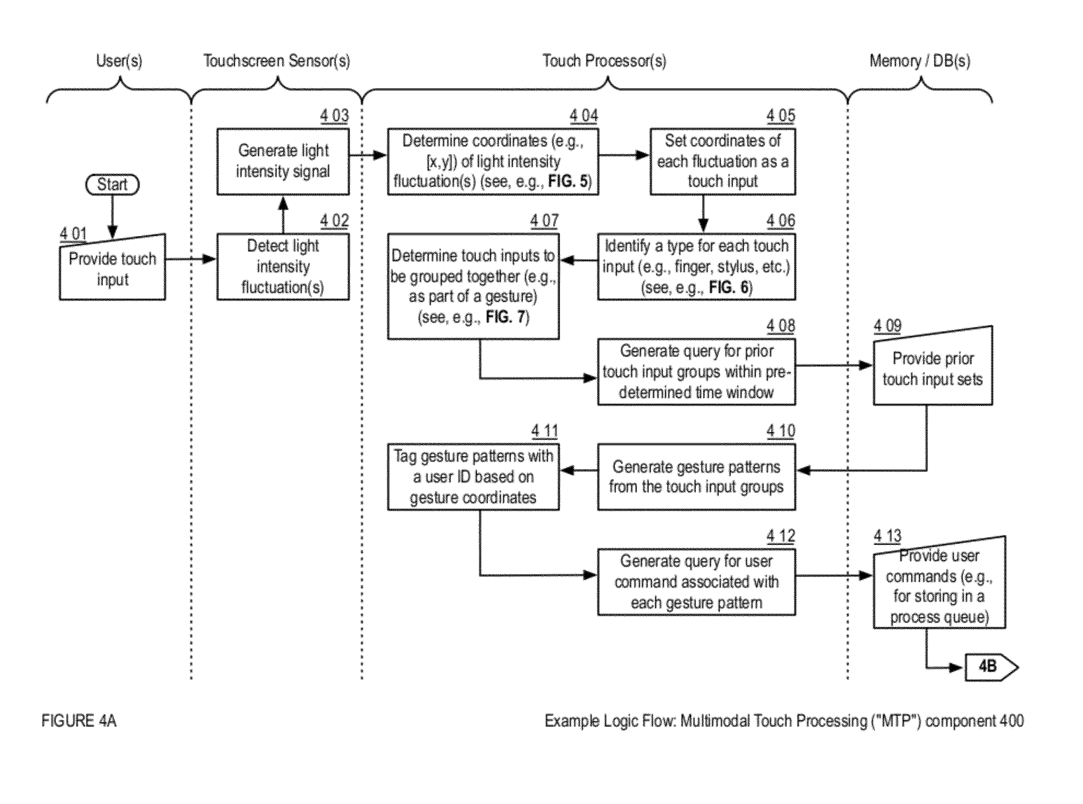

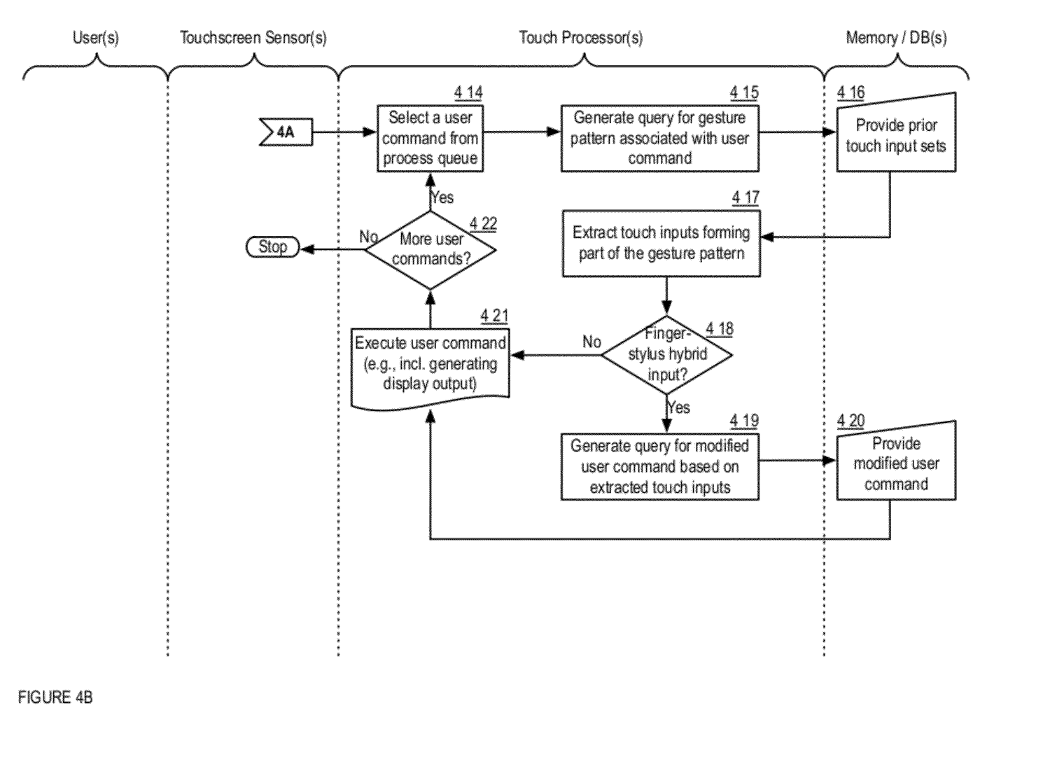

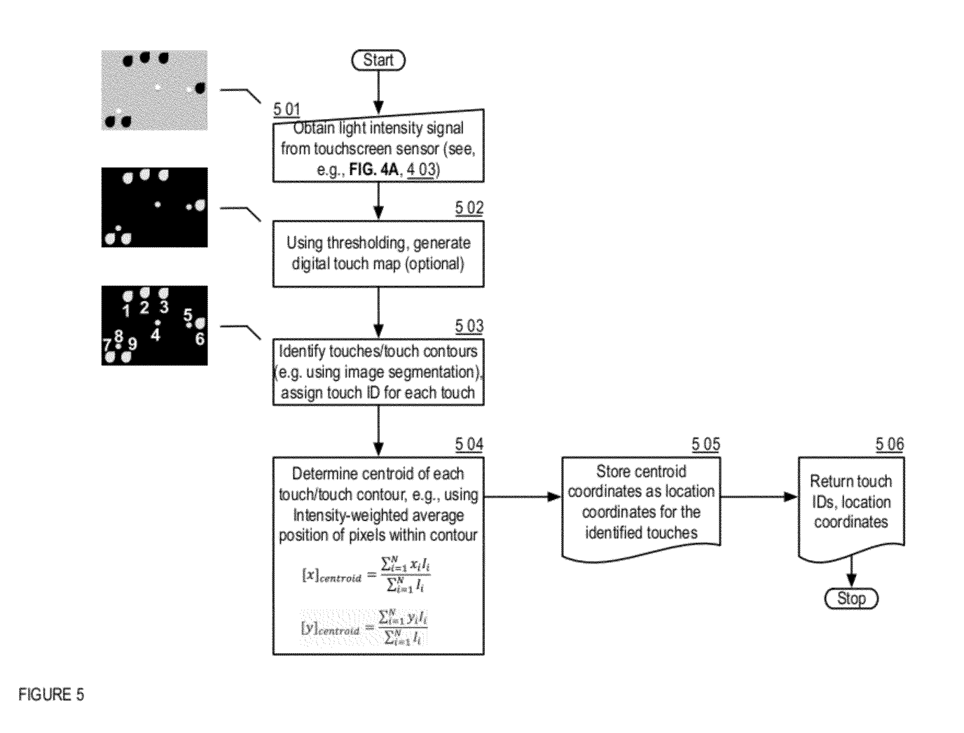

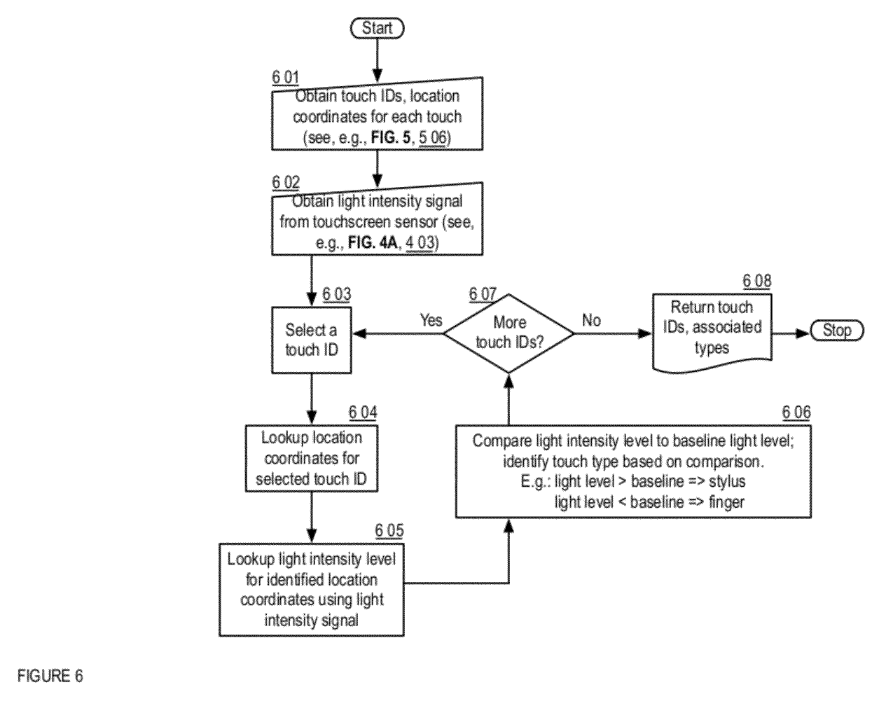

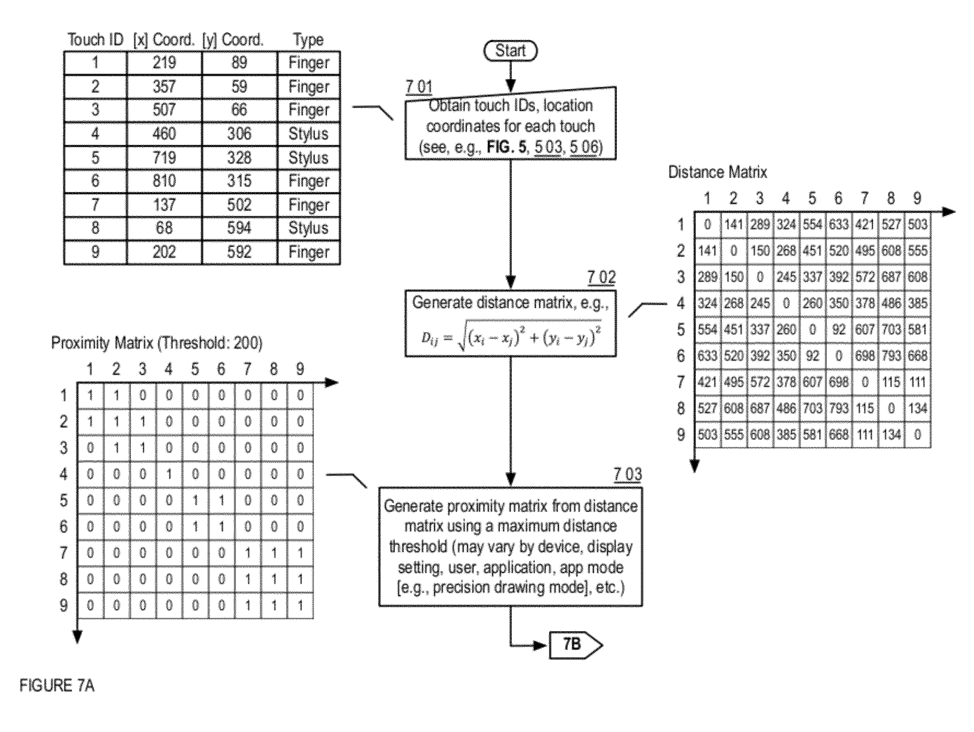

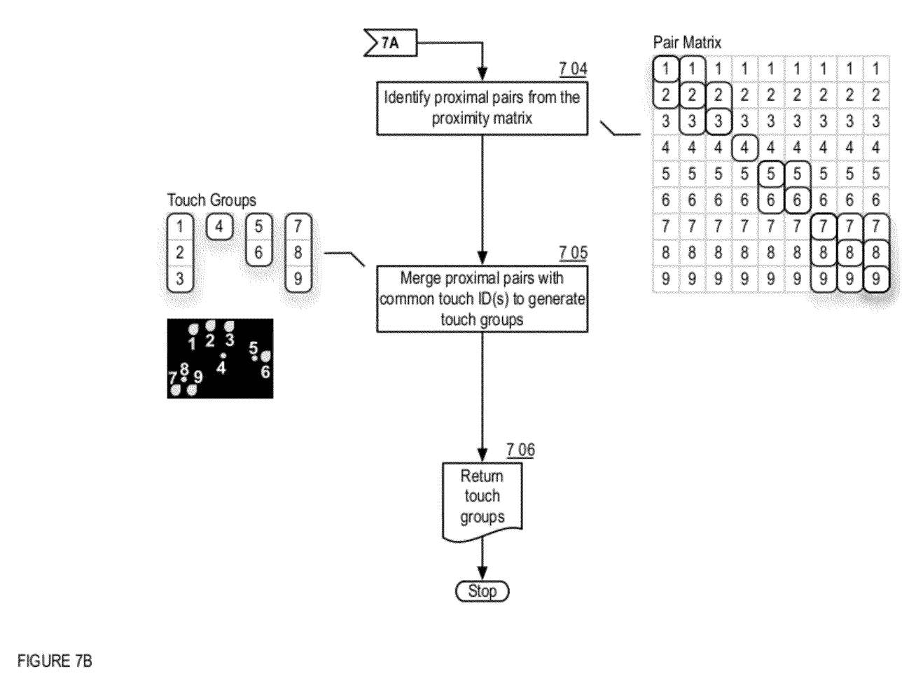

FIGS. 4A-B show logic flow diagrams illustrating example aspects of multimodal touch processing in some embodiments of the MTI, e.g., a Multimodal Touch Processing (“MTP”) component 400. With reference to FIG. 4A, in some embodiments, a user may provide a touch input, 401, into a touchscreen of the MTI. For example, the user may utilize one or more finger touches, one or more light/RF-emitting styli, or any combinations thereof. In the embodiments where the touchscreen utilizes a light-based technique for detecting user touches, the touchscreen sensors may detect fluctuations (increases or decreases) in light levels due to the user touches, 402. Using the detected fluctuations, the touchscreen sensors may generate a light intensity signal, 403, and provide the light intensity signal to one or more touch process(s) (“touch processor”). For example, the sensors may communicate the light intensity signal over an analog communication channel, such as a copper wire, followed by digital sampling by a data acquisition board. As another example, the sensors may communicate data packets over a network, e.g., using a (Secure) HyperText Transfer Protocol (HTTP(S)). The touch processor may obtain the light intensity signal, and may determine the coordinates of the user touches based on the light intensity fluctuations, 404. For example, the touch processor may execute a touch coordinate determination component such as the example TCD 500 component described below in the discussion with reference to FIG. 5. Based on this computation, the touch processor may produce data such as the example coordinates provided in the inset with reference to FIG. 7, 701. The touch processor may set each of the coordinate sets (e.g., {x,y,z}) as a touch input, 405. In some embodiments, the touch processor may identify a type (e.g., finger, stylus, etc.) for each touch input provided by the user, 406. For example, the touch processor may execute a touch type identification component such as the example TTI 600 component described below in the discussion with reference to FIG. 6. Based on this computation, the touch processor may produce data such as the example touch types provided in the inset with reference to FIG. 7, 701. In some embodiments, the touch processor may determine, 407, which touch inputs provided by the user should be grouped together as part of a single gesture (e.g., “should the two finger touches and one stylus touch be considered part of a single gesture on behalf of one user?”). For example, the touch processor may execute a touch group resolution component such as the example TGR 700 component described further below in the discussion with reference to FIGS. 7A-B. Based on this computation, the touch processor may produce data such as the example touch groups provided in the inset with reference to FIG. 7, 705. Upon identifying the gestures for the user(s), the touch processor may generate query(ies) for a database, 408, for prior touch input groups within a pre-determined time window to be combined as part of a gesture sequence, 408. For example, a four-finger swipe may be considered not an instantaneous gesture; rather, the gesture may be identified by tracking the movement of four fingers of a user over a finite time window. As another example, a gesture may require two distinct sets of user touches (e.g., a two-finger tap, and a one-stylus tap). Based on the query(ie), the queried database/memory may provide prior touch inputs sets, 409, for identifying gesture sequences. For example, the touch processor may utilize a Hypertext Preprocessor (PHP) script including Structured Query Language (SQL) commands to query a relational database for the prior touch input sets. Using the prior touch input sets, the touch processor may generate gesture patterns/sequences from the touch input groups, 410. In some embodiments, based on the location coordinates of the touch input groups, the touch processor may tag each gesture pattern/sequence with a user ID (either of a user known to be at the approximate spatial location (e.g., using camera-based facial recognition, user login at the touchscreen location, etc.), or a randomly generated ID, which may be assigned to any other gesture sequences performed at the approximate location). For each gesture pattern/sequence, the touch process may query a database/memory for user command(s) associated with the gesture patterns/sequences, 412. In response, the database/memory may provide the requested user command(s), which may be stored in a process queue for execution.

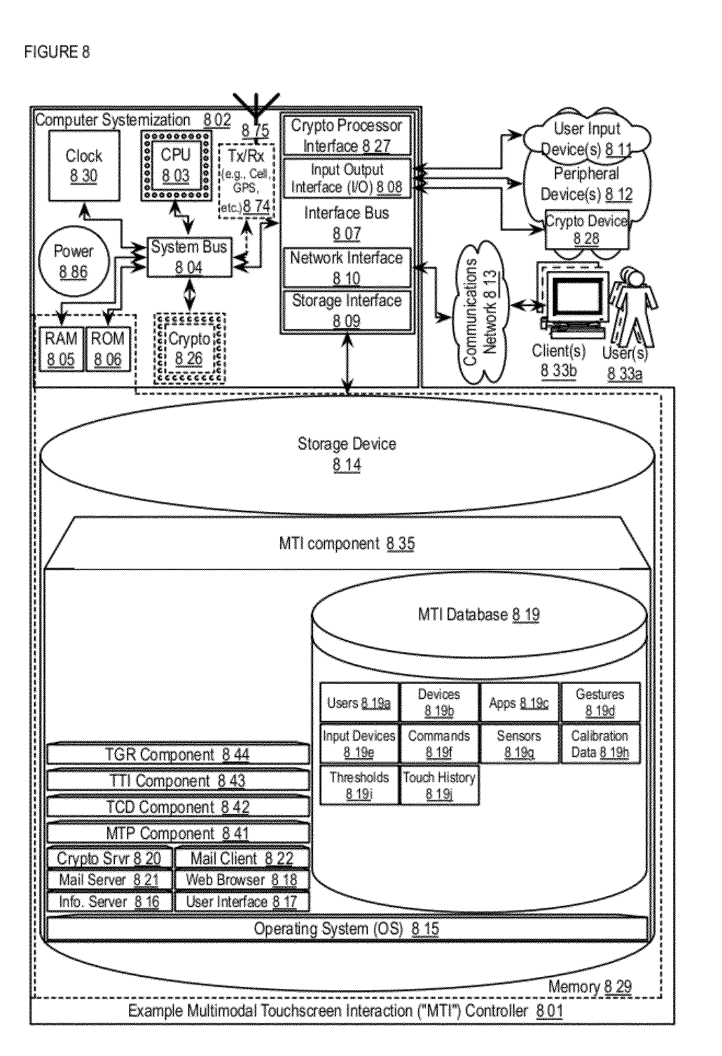

With reference to FIG. 4B, in some embodiments, the touch processor may select a user command from a process queue (e.g., optionally generated as per the procedure described above in the discussion with reference to FIG. 4A), 414. Optionally, the touch processor may generate a query for the gesture pattern associated with the user command, 415. In response, the database/memory may provide the prior touch input sets that formed part of the gesture pattern, 416. The touch processor may extract the touch inputs forming part of the gesture pattern, 417. For example, the touch process may parse the data using a parser such as the example ones described below in the discussion with reference to FIG. 8. The touch processor may determine whether any of the touch inputs sets included a hybrid stylus-finger user input, 418. If any of the touch inputs sets included a hybrid stylus-finger user input, 418, option “Yes,” the touch process may generate a query for any modifications to the user command normally associated with the gesture, 419. Upon obtaining any modifications to the user commands from the database/memory, 420, the touch processor may execute the (modified) user command, e.g., including generating any visual/audio display output for presentation via the touchscreen (or other networked touchscreens), 421. The touch processor may perform such a procedure for each user command stored in the process queue (see 422).

FIG. 5 shows a logic flow diagram illustrating example aspects of touch coordinate determination in some embodiments of the MTI, e.g., a Touch Coordinate Determination (“TCD”) component 500. In some implementations, a touch processor of the MTI may obtain a light intensity signal from a touchscreen sensor for determining the coordinates of any user touch that may be encoded into the light intensity signal, 501. The touch processor may optionally generate a digital touch map using the light intensity signal, 502. For example, the touch processor may apply a thresholding procedure to the light intensity signal such that all pixels below the threshold are set to zero, and all above are set to one. Alternatively, two separate thresholds may be applied so that the pixels corresponding to both light-emitting styli inputs and light-occluding finger-inputs are set to one, and all other pixels are set to zero. Using the digital touch map, the touch processor may identify each touch (or its contour). For example, the touch processor may use an image segmentation algorithm to identify each touch or its contour, 503. Upon identifying each (segmented) touch image object, the touch processor may calculate a centroid based on an Intensity-weighted average position of pixels within the contours of the segmented touch image object, 504. The touch processor may store the centroids {x,y,z} as location coordinates for the identified touches, and may return these as the determined location coordinates for the touches, 506.

FIG. 6 shows a logic flow diagram illustrating example aspects of touch type identification in some embodiments of the MTI, e.g., a Touch Type Identification (“TTP”) component 600. In some embodiments, a touch processor of the MTI may obtain touch IDs, and location coordinates for each touch (see, e.g., FIG. 5, 506), for identifying a type of touch for each touch ID, 601. The touch processor may also obtain the original light intensity signal (see, e.g., FIG. 4A, 403), 602. The touch process may select a touch ID, 603, and look up the location coordinates for the selected touch ID, 604. Using the location coordinates, the touch processor may lookup the original intensity level of the pixel corresponding to the location coordinates (or an average for a window of pixels in its vicinity) using the light intensity signal, 605. The touch processor may compare the light intensity level samples to the threshold(s) for stylus input to be detected and/or for a finger input to be detected. Based on the comparison, the touch processor may identify the touch type as either a stylus input or a finger input, 606. The touch processor may perform such a procedure for each touch ID obtained (see 607). The touch process may return the touch IDs and touch types for further processing, 608.

FIGS. 7A-B show logic flow diagrams illustrating example aspects of touch group resolution in some embodiments of the MTI, e.g., a Touch Group Resolution (“TGR”) component 700. With reference to FIG. 7A, in some implementations, a touch processor of the MTI may obtain touch IDs, and location coordinates for each touch, 701 (see inset), to resolve which touches of one or more users should be grouped together as part of a single gesture or gesture pattern/sequence. The touch processor may calculate the distance between each pair of touch inputs using the location coordinates, 702 (see inset, distance matrix). The touch processor may apply a thresholding procedure to the distance matrix, such that all matrix elements above the threshold are set to zero, and those below are set to one. Accordingly, in some embodiments, only those touches that are sufficiently close to another touch (as gauged by whether they are below the threshold distance necessary to qualify as being part of a single gesture, pattern, or sequence) are set to one. The diagonal elements in the proximity matrix (see 703, inset) are always one because each touch is in its own vicinity. Thus, if a touch is all by itself, the diagonal element corresponding to its ID will be one, and all other elements in its corresponding column will be zero (see, e.g., 703, inset, column 4). With reference to FIG. 7B, in some implementations, the touch processor may utilize the proximity matrix of 703 to identify those touches that are proximal pairs, 704 (see inset, pair matrix). The touch processor may merge proximal pairs together that have at least one common touch ID, 705, to generate the touch group (see 705, inset), which the touch process may return, 706, for further processing.

### MTI Controller

FIG. 8 shows a block diagram illustrating embodiments of a MTI controller 801. In this embodiment, the MTI controller 801 may serve to aggregate, process, store, search, serve, identify, instruct, generate, match, and/or facilitate interactions with a computer through various technologies, and/or other related data.

Typically, users, e.g., 833a, which may be people and/or other systems, may engage information technology systems (e.g., computers) to facilitate information processing. In turn, computers employ processors to process information; such processors 803 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 829 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the MTI controller 801 may be connected to and/or communicate with entities such as, but not limited to: one or more users from user input devices 811; peripheral devices 812; an optional cryptographic processor device 828; and/or a communications network 813. For example, the MTI controller 801 may be connected to and/or communicate with users, e.g., 833a, operating client device(s), e.g., 833b, including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s), and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The MTI controller 801 may be based on computer systems that may comprise, but are not limited to, components such as: a computer systemization 802 connected to memory 829.

### Computer Systemization

A computer systemization 802 may comprise a clock 830, central processing unit (“CPU(s)” and/or “processor(s)” (these terms are used interchangeable throughout the disclosure unless noted to the contrary)) 803, a memory 829 (e.g., a read only memory (ROM) 806, a random access memory (RAM) 805, etc.), and/or an interface bus 807, and most frequently, although not necessarily, are all interconnected and/or communicating through a system bus 804 on one or more (mother)board(s) 802 having conductive and/or otherwise transportive circuit pathways through which instructions (e.g., binary encoded signals) may travel to effectuate communications, operations, storage, etc. The computer systemization may be connected to a power source 886; e.g., optionally the power source may be internal. Optionally, a cryptographic processor 826 and/or transceivers (e.g., ICs) 874 may be connected to the system bus. In another embodiment, the cryptographic processor and/or transceivers may be connected as either internal and/or external peripheral devices 812 via the interface bus I/O. In turn, the transceivers may be connected to antenna(s) 875, thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing MTI controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 829 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the MTI controller and beyond through various interfaces. Should processing requirements dictate a greater amount speed and/or capacity, distributed processors (e.g., Distributed MTI), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the MTI may be achieved by implementing a microcontroller such as CAST's R8051XC2 microcontroller; Intel's MCS 51 (i.e., 8051 microcontroller); and/or the like. Also, to implement certain features of the MTI, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the MTI component collection (distributed or otherwise) and/or features may be implemented via the microprocessor and/or via embedded components; e.g., via ASIC, coprocessor, DSP, FPGA, and/or the like. Alternately, some implementations of the MTI may be implemented with embedded components that are configured and used to achieve a variety of features or signal processing.

Depending on the particular implementation, the embedded components may include software solutions, hardware solutions, and/or some combination of both hardware/software solutions. For example, MTI features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the MTI features. A hierarchy of programmable interconnects allow logic blocks to be interconnected as needed by the MTI system designer/administrator, somewhat like a one-chip programmable breadboard. An FPGA's logic blocks can be programmed to perform the operation of basic logic gates such as AND, and XOR, or more complex combinational operators such as decoders or simple mathematical operations. In most FPGAs, the logic blocks also include memory elements, which may be circuit flip-flops or more complete blocks of memory. In some circumstances, the MTI may be developed on regular FPGAs and then migrated into a fixed version that more resembles ASIC implementations. Alternate or coordinating implementations may migrate MTI controller features to a final ASIC instead of or in addition to FPGAs. Depending on the implementation all of the aforementioned embedded components and microprocessors may be considered the “CPU” and/or “processor” for the MTI.

### Power Source

The power source 886 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 886 is connected to at least one of the interconnected subsequent components of the MTI thereby providing an electric current to all subsequent components. In one example, the power source 886 is connected to the system bus component 804. In an alternative embodiment, an outside power source 886 is provided through a connection across the I/O 808 interface. For example, a USB and/or IEEE 1394 connection carries both data and power across the connection and is therefore a suitable source of power.

### Interface Adapters

Interface bus(ses) 807 may accept, connect, and/or communicate to a number of interface adapters, conventionally although not necessarily in the form of adapter cards, such as but not limited to: input output interfaces (I/O) 808, storage interfaces 809, network interfaces 810, and/or the like. Optionally, cryptographic processor interfaces 827 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 809 may accept, communicate, and/or connect to a number of storage devices such as, but not limited to: storage devices 814, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 810 may accept, communicate, and/or connect to a communications network 813. Through a communications network 813, the MTI controller is accessible through remote clients 833b (e.g., computers with web browsers) by users 833a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed MTI), architectures may similarly be employed to pool, load balance, and/or otherwise increase the communicative bandwidth required by the MTI controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 810 may be used to engage with various communications network types 813. For example, multiple network interfaces may be employed to allow for the communication over broadcast, multicast, and/or unicast networks.

Input Output interfaces (I/O) 808 may accept, communicate, and/or connect to user input devices 811, peripheral devices 812, cryptographic processor devices 828, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 811 often are a type of peripheral device 812 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 812 may be connected and/or communicate to I/O and/or other facilities of the like such as network interfaces, storage interfaces, directly to the interface bus, system bus, the CPU, and/or the like. Peripheral devices may be external, internal and/or part of the MTI controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 828), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the MTI controller may be embodied as an embedded, dedicated, and/or monitor-less (i.e., headless) device, wherein access would be provided over a network interface connection.

Cryptographic units such as, but not limited to, microcontrollers, processors 826, interfaces 827, and/or devices 828 may be attached, and/or communicate with the MTI controller. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: the Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 829. However, memory is a fungible technology and resource, thus, any number of memory embodiments may be employed in lieu of or in concert with one another. It is to be understood that the MTI controller and/or a computer systemization may employ various forms of memory 829. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 829 will include ROM 806, RAM 805, and a storage device 814. A storage device 814 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 829 may contain a collection of program and/or database components and/or data such as, but not limited to: operating system component(s) 815 (operating system); information server component(s) 816 (information server); user interface component(s) 817 (user interface); Web browser component(s) 818 (Web browser); database(s) 819; mail server component(s) 821; mail client component(s) 822; cryptographic server component(s) 820 (cryptographic server); the MTI component(s) 835; and/or the like (i.e., collectively a component collection). These components may be stored and accessed from the storage devices and/or from storage devices accessible through an interface bus. Although non-conventional program components such as those in the component collection, typically, are stored in a local storage device 814, they may also be loaded and/or stored in memory such as: peripheral devices, RAM, remote storage facilities through a communications network, ROM, various forms of memory, and/or the like.

### Operating System

The operating system component 815 is an executable program component facilitating the operation of the MTI controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Nan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the MTI controller to communicate with other entities through a communications network 813. Various communication protocols may be used by the MTI controller as a subcarrier transport mechanism for interaction, such as, but not limited to: multicast, TCP/IP, UDP, unicast, and/or the like.

### Information Server

An information server component 816 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the MTI controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the MTI database 819, operating systems, other program components, user interfaces, Web browsers, and/or the like.

Access to the MTI database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the MTI. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the MTI as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component 817 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 818 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the MTI enabled nodes. The combined application may be nugatory on systems employing standard Web browsers.

### Mail Server

A mail server component 821 is a stored program component that is executed by a CPU 803. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the MTI.

Access to the MTI mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 822 is a stored program component that is executed by a CPU 803. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 820 is a stored program component that is executed by a CPU 803, cryptographic processor 826, cryptographic processor interface 827, cryptographic processor device 828, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the MTI may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the MTI component to engage in secure transactions if so desired. The cryptographic component facilitates the secure accessing of resources on the MTI and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The MTI Database

The MTI database component 819 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the MTI database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of capabilities encapsulated within a given object. If the MTI database is implemented as a data-structure, the use of the MTI database 819 may be integrated into another component such as the MTI component 835. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 819 includes several tables 819a-j. A Users table 819a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a MTI. A Devices table 819b may include fields such as, but not limited to: device_ID, device_name, device_IP, device_MAC, device_type, device_model, device_version, device_OS, device_apps_list, devic_securekey, and/or the like. An Apps table 819c may include fields such as, but not limited to: app_ID, app_name, app_type, app_dependencies, and/or the like. A Gestures table 819d may include fields such as, but not limited to: gesture_id, gesture_name, gesture_touch_group_definition, gesture_timing_sequence, gesture_enabled_flag, gesture_settings_list, gesture_settings_values, and/or the like. An Input Devices table 819e may include fields such as, but not limited to: device_ID, device_name, device_IP, device_MAC, device_type, device_model, device_version, device_OS, device_apps_list, device_securekey, and/or the like. A Commands table 819f may include fields such as, but not limited to: command_id, command_name, command_syntax, command_compiler, command_inputs, command_exceptions_list, command_gesture_trigger, and/or the like. A Sensors table 819g may include fields such as, but not limited to: sensor_id, sensor_name, sensor_type, last_calibrated, sensor_data_rate, sensor_data_format, sensor_data_error_estimate, sensor_trigger_type, sensor_trigger_condition, sensor_burst_enable_flag, sensor_continuous_enable_flag, and/or the like. A Calibration Data table 819h may include fields such as, but not limited to: calibration_id, calibration_type, calibration_device_applicable, calibration_variables_list, calibration_variables_values, and/or the like. A Thresholds table 819i may include fields such as, but not limited to: threshold_id, threshold_name, threshold_type, threshold_dynamic_parameter, threshold_value, threshold_delta, threshold_last_update, threshold_calibrated_flag, and/or the like. A Touch History table 819j may include fields such as, but not limited to: timestamp, user_id, user_app_id, user_device_id, user_gesture_id, user_command_id, and/or the like.

In one embodiment, the MTI database may interact with other database systems. For example, employing a distributed database system, queries and data access by search MTI component may treat the combination of the MTI database, an integrated data security layer database as a single database entity.

In one embodiment, user programs may contain various user interface primitives, which may serve to update the MTI. Also, various accounts may require custom database tables depending upon the environments and the types of clients the MTI may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 819a-j. The MTI may be configured to keep track of various settings, inputs, and parameters via database controllers.

The MTI database may communicate to and/or with other components in a component collection, including itself, and/or facilities of the like. Most frequently, the MTI database communicates with the MTI component, other program components, and/or the like. The database may contain, retain, and provide information regarding other nodes and data.

### The MTIs

The MTI component 835 is a stored program component that is executed by a CPU. In one embodiment, the MTI component incorporates any and/or all combinations of the aspects of the MTI discussed in the previous figures. As such, the MTI affects accessing, obtaining and the provision of information, services, transactions, and/or the like across various communications networks.

The MTI component may transform multi-user, multi-modal touchscreen input gestures via MTI components into user-customized computation result displays, and/or the like and use of the MTI. In one embodiment, the MTI component 835 takes inputs (e.g., touch input 401; prior touch input sets 409; user commands 413, 416; modified user commands 420; light intensity signal 501; touch IDs, location coordinates 601, 701; and/or the like), and transforms them via MTI components (e.g., MTP 841; TCD 842; TTI 843; TGR 844; and/or the like), into outputs (e.g., executed user commands 421; centroid coordinates 505; touch ID(s), location coordinates 506; touch ID(s), associated types 608; touch groups 706; and/or the like).

The MTI component enabling access of information between nodes may be developed by employing standard development tools and languages such as, but not limited to: Apache components, Assembly, ActiveX, binary executables, (ANSI) (Objective-) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the MTI server employs a cryptographic server to encrypt and decrypt communications. The MTI component may communicate to and/or with other components in a component collection, including itself, and/or facilities of the like. Most frequently, the MTI component communicates with the MTI database, operating systems, other program components, and/or the like. The MTI may contain, communicate, generate, obtain, and/or provide program component, system, user, and/or data communications, requests, and/or responses.

### Distributed MTIs

The structure and/or operation of any of the MTI node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the MTI controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:
w3c-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the MTI controller may be executing a PHP script implementing a Secure Sockets Layer (“SSL”) socket server via the information server, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

<?PHP
header(′Content-Type: text/plain′);
// set ip address and port to listen to for incoming data
$address = ‘192.168.0.100’;
$port = 255;
// create a server-side SSL socket, listen for/accept incoming
communication
$sock = socket_create(AF_INET, SOCK_STREAM, 0);
socket_bind($sock, $address, $port) or die(‘Could not bind to address’);
socket_listen($sock);
$client = socket_accept($sock);
// read input data from client device in 1024 byte blocks until end of
message
do {

$ input = “”;
$input = socket_read($client, 1024);
$data .= $input;

} while($input != “”);
// parse data to extract variables
$obj = json_decode($data, true);
// store input data in a database
mysql_connect(″201.408.185.132″,$DBserver,$password); // access
database server
mysql_select(″CLIENT_DB.SQL″); // select database to append
mysql_query(“INSERT INTO UserTable (transmission)
VALUES ($data)”); // add data to UserTable table in a CLIENT database
mysql_close(″CLIENT_DB.SQL″); // close connection to database
?>

Also, the following resources may be used to provide example embodiments regarding SOAP parser implementation:
http://www.xav.com/perl/site/lib/SOAP/Parser.html
http://publib.boulder.ibm.com/infocenter/tivihelp/v2r1/index.jsp?topic=/com.ibm.IBMDI.doc/referenceguide295.htm

and other parser implementations:
http://publib.boulder.ibm.com/infocenter/tivihelp/v2r1/index.jsp?topic=/com.ibm.IBMDI.doc/referenceguide259.htm

all of which are hereby expressly incorporated by reference herein.

In order to address various issues and advance the art, the entirety of this application for MULTIMODAL TOUCHSCREEN INTERACTION APPARATUSES, METHODS AND SYSTEMS (including the Cover Page, Title, Headings, Field, Background, Summary, Brief Description of the Drawings, Detailed Description, Claims, Abstract, Figures, Appendices and/or otherwise) shows by way of illustration various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations, including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a MTI individual and/or enterprise user, database configuration and/or relational model, data type, data transmission and/or network framework, syntax structure, and/or the like, various embodiments of the MTI may be implemented that enable a great deal of flexibility and customization. For example, aspects of the MTI may be adapted for 3D immersion systems, virtual reality experiences, office productivity suites, and/or the like. While various embodiments and discussions of the MTI have been directed to human-computer interaction, however, it is to be understood that the embodiments described herein may be readily configured and/or customized for a wide variety of other applications and/or implementations.

What is claimed is:

1. A multimodal touchscreen interaction processor-implemented method, comprising:
obtaining, from a touchscreen sensor, a sensor signal including information on a user touch event on a touchscreen;
determining, via a processor, location coordinates of the user touch event from the sensor signal;
identifying a touch type of the user touch event from the sensor signal; and
determining, via the processor, a user touchscreen gesture using the touch type of the user touch event.

2. The method of claim 1, further comprising:
querying a memory for a user command associated with the user touchscreen gesture; and
executing, via the processor the user command.

3. The method of claim 2, further comprising:
querying a memory for a prior user touch event within a predetermined time window; and
identifying a gesture pattern using the prior user touch event and the user touchscreen gesture.

4. The method of claim 3, wherein the query for the user command associated with the user touchscreen gesture is based on the identified gesture pattern.

5. The method of claim 2, further comprising:
identifying a modification to the user command associated with the user touchscreen gesture, based on the identified touch type of the user touch event; and
wherein executing, via the processor the user command is based on the modification to the user command based on the identified touch type.

6. The method of claim 1, wherein the user touch event includes a finger touch and a stylus touch.

7. The method of claim 6, wherein the user touch event includes a multiple-finger touch and a stylus touch.

8. A multimodal touchscreen interaction system, comprising:
a processor; and
a memory disposed in communication with the processor and storing processor-issuable instructions to:
obtain, from a touchscreen sensor, a sensor signal including information on a user touch event on a touchscreen;
determine, via the processor, location coordinates of the user touch event from the sensor signal;
identify a touch type of the user touch event from the sensor signal; and
determine, via the processor, a user touchscreen gesture using the touch type of the user touch event.

9. The system of claim 8, the memory further storing instructions to:
query a memory for a user command associated with the user touchscreen gesture; and
execute, via the processor the user command.

10. The system of claim 9, the memory further storing instructions to:
query a memory for a prior user touch event within a predetermined time window; and
identify a gesture pattern using the prior user touch event and the user touchscreen gesture.

11. The system of claim 10, wherein the query for the user command associated with the user touchscreen gesture is based on the identified gesture pattern.

12. The system of claim 9, the memory further storing instructions to:
identify a modification to the user command associated with the user touchscreen gesture, based on the identified touch type of the user touch event; and
wherein executing, via the processor the user command is based on the modification to the user command based on the identified touch type.

13. The system of claim 8, wherein the user touch event includes a finger touch and a stylus touch.

14. The system of claim 13, wherein the user touch event includes a multiple-finger touch and a stylus touch.

15. A processor-readable tangible medium storing processor-issuable multimodal touchscreen interaction instructions to:
obtain, from a touchscreen sensor, a sensor signal including information on a user touch event on a touchscreen;
determine, via the processor, location coordinates of the user touch event from the sensor signal;
identify a touch type of the user touch event from the sensor signal; and
determine, via the processor, a user touchscreen gesture using the touch type of the user touch event.

16. The medium of claim 15, further storing instructions to:
query a memory for a user command associated with the user touchscreen gesture; and
execute, via the processor the user command.

17. The medium of claim 16, further storing instructions to:
query a memory for a prior user touch event within a predetermined time window; and
identify a gesture pattern using the prior user touch event and the user touchscreen gesture.

18. The medium of claim 17, wherein the query for the user command associated with the user touchscreen gesture is based on the identified gesture pattern.

19. The medium of claim 16, further storing instructions to:
identify a modification to the user command associated with the user touchscreen gesture, based on the identified touch type of the user touch event; and
wherein executing, via the processor the user command is based on the modification to the user command based on the identified touch type.

20. The medium of claim 15, wherein the user touch event includes a finger touch and a stylus touch.

21. The medium of claim 20, wherein the user touch event includes a multiple-finger touch and a stylus touch.
